(19) United States
(12) Patent Application Publication
(10) Pub. No.: US 2025/0238199 A1
(43) Pub. Date: Jul. 24, 2025

(54) STORING FLOATING-POINT VALUES ACCORDING TO AN EXTENDED QFLOAT FLOATING-POINT (xqFP) FORMAT IN PROCESSOR DEVICES

(71) Applicant: QUALCOMM Incorporated, San Diego, CA (US)

(72) Inventors: Albert Danysh, Austin, TX (US); Eric Wayne Mahurin, Austin, TX (US); Diego Andres Guerra, Austin, TX (US); Butchi Venkata Chaitanya Akondi, Austin, TX (US)

(21) Appl. No.: 18/417,212

(22) Filed: Jan. 19, 2024

(51) Int. Cl. G06F 7/499

(52) U.S. Cl. CPC G06F 7/49915

(57) ABSTRACT

Storing floating-point values according to an extended QFloat floating-point (xqFP) format in processor devices is disclosed herein. In some aspects, a processor device comprises a register file comprising a plurality of registers, and comprises a floating-point unit (FPU) circuit that is configured to store a first floating-point value in a register of the plurality of registers. The first floating-point value is formatted according to the xqFP format that comprises an exponent field and a significand field. The significand field is formatted as a signed one's complement value, and comprises a sign bit, an explicit most-significant-bit (MSB), a fractional field, and a deferred increment bit that represents a value of one-half (½) unit of least precision (ULP).

### BACKGROUND

### I. Field of the Disclosure

The technology of the disclosure relates generally to handling of floating-point numbers by a processor device, and, in particular, to formats for representing and handling floating-point numbers by a floating-point unit (FPU) circuit of a processor device.

### II. Background

Microprocessors, also referred to herein as “processors,” perform computational tasks for a wide variety of applications by executing instructions to perform logical and mathematical operations on data, including operations using floating-point numbers. As used herein, “floating-point numbers” refer to representations of real numbers using a “significand” that comprises an integer with a specific precision expressing a binary fraction, and an “exponent” that comprises an integer of a specific base. Floating-point numbers are useful in representing numbers of different orders of magnitude using a fixed number of digits.

Different computing systems may provide varying formats for representing floating-point numbers. To provide a common floating-point format, the Institute of Electrical and Electronics Engineers (IEEE) created a technical standard for floating-point arithmetic known as the IEEE-754 standard. The IEEE-754 standard defines arithmetic formats for floating-point data, and also specifies interchange formats, rounding rules, floating-point operations, and exception handling. Floating-point numbers formatted according to the IEEE-754 standard are normalized using an implicit most-significant bit (MSB), which enables greater precision. The IEEE-754 standard also enables representations for positive zero (+0) and negative zero (−0) values, and provides representation and handling for infinity and Not-A-Number (NaN) values. However, implementing floating-point processing that is fully compliant with the IEEE-754 standard may be relatively expensive in terms of processor area and timing paths, and the requirement that floating-point numbers be normalized may require additional calculations and rounding operations to be performed.

To enable floating-point processing in a more hardware-efficient manner, Qualcomm developed an intermediate register format for floating-point numbers known as QFloat. A QFloat-formatted floating-point number comprises a sign bit, a significand field, and an exponent field, with the significand field formatted according to a two's complement fixed-point format with no implied MSB. QFloat-formatted values are rounded using Von Neumann rounding, with an implicit least-significant-bit (LSB). The QFloat format can be implemented in a more hardware-efficient fashion than the full IEEE-754 standard because existing fixed-point data paths can be adapted to support QFloat. However, for applications that require full IEEE-754 compliance, QFloat may raise a number of issues. For instance, QFloat does not include representations for positive zero (+0) or negative zero (−0), or for infinity and NaN values. The implied LSB of the QFloat format may introduce errors into otherwise precise results, and floating-point numbers formatted using QFloat provide less precision using the same bit width as corresponding numbers formatted according to IEEE-754. Additionally, rounding under QFloat may result in different results at tiebreaker values (i.e., values equidistant from potential odd- or even-rounded values) than rounding under IEEE-754. Accordingly, it is desirable to provide an alternative floating-point format that can generate values compliant with the IEEE-754 standard while maintaining the hardware efficiency of the QFloat format.

### SUMMARY OF THE DISCLOSURE

Aspects disclosed in the detailed description include storing floating-point values according to an extended QFloat floating-point (xqFP) format in processor devices. Related apparatus and methods are also disclosed. In this regard, in some exemplary aspects disclosed herein, a processor device includes an instruction processing circuit that fetches, decodes, and executes computer-executable instructions in an instruction stream. The instruction processing circuit comprises a floating-point unit (FPU) circuit that is configured to store floating-point values according to an xqFP format. In exemplary operation, the FPU circuit of the processor device receives a floating-point input value formatted according to the Institute of Electrical and Electronics Engineers (IEEE) Standard for Floating-Point Arithmetic (IEEE-754) standard. The FPU circuit converts the floating-point input value to a floating-point value formatted according to the xqFP format, which comprises an exponent field and a significand field. The significand field is formatted as a signed one's complement value, and comprises a sign bit, an explicit most-significant bit (MSB), a fractional field, and a deferred increment bit that represents a value of one-half (½) unit of least precision (ULP). Some aspects may provide that the significand field further comprises a quarter-ULP bit that represents a value of one-fourth (¼) ULP.

In some aspects, the first floating-point value is unnormalized, and the explicit MSB indicates a value of an MSB of the first floating-point value. The first floating-point value according to some aspects may comprise one (1) of two (2) different representations: a first representation wherein the significand field stores a numeric value with the deferred increment bit set to a value of zero (0), and a second representation wherein the significand field stores the numeric value minus a value of one (1) with the deferred increment bit set to a value of one (1).

According to some aspects, converting the floating-point input value to the first floating-point value may comprise rounding the first floating-point value to a nearest even value (e.g., by determining whether the floating-point input value is nearest to but less than the nearest even value, and, if so, setting the deferred increment bit). Some aspects may provide that converting the floating-point input value to the first floating-point value may comprise the FPU circuit normalizing a subnormal value.

The FPU circuit is further configured to store the first floating-point value in a register of a plurality of registers of a register file of the processor device. The FPU circuit then performs a floating-point operation (e.g., a multiply operation, an addition operation, or a multiply-and-add operation, as non-limiting examples) using the first floating-point value to generate a second floating-point value formatted according to the xqFP format. In some aspects, performing the floating-point operation using the first floating-point value to generate the second floating-point value may comprise negating the first floating-point value by, e.g., performing a one's complement operation on the first floating-point value.

The FPU circuit converts the second floating-point value to a floating-point output value formatted according to the IEEE-754 standard. According to some aspects, converting the second floating-point value to the floating-point output value formatted according to IEEE-754 may comprise rounding the second floating-point value to a nearest odd value (e.g., by determining whether the rounded second floating-point value results in a tiebreaker value, and, if so, rounding the second floating-point value using the quarter-ULP bit to avoid a double-round error on a subsequent nearest-even-rounding operation). Some aspects in which the first floating-point value is a subnormal value may provide that converting the second floating-point value to the floating-point output value formatted according to IEEE-754 comprises converting the second floating-point value using the quarter-ULP bit to avoid a double-round error on a subsequent nearest-even-rounding operation.

In another aspect, a processor device is disclosed. The processor device comprises a register file that comprises a plurality of registers. The processor device further comprises an FPU circuit that is configured to store a first floating-point value in a register of the plurality of registers. The first floating-point value is formatted according to an xqFP format that comprises an exponent field and a significand field. The significand field is formatted as a signed one's complement value, and comprises a sign bit, an explicit MSB, a fractional field, and a deferred increment bit that represents a value of one-half (½) ULP.

In another aspect, a processor device is disclosed. The processor device comprises means for receiving a floating-point input value formatted according to IEEE-754. The processor device further comprises means for converting the floating-point input value to a first floating-point value formatted according to an xqFP format, wherein the first floating-point value formatted according to the xqFP format comprises an exponent field and a significand field. The significand field is formatted as a signed one's complement value and comprises a sign bit, an explicit MSB, a fractional field, and a deferred increment bit that represents a value of one-half (½) ULP. The processor device also comprises means for storing the first floating-point value in a register of a plurality of registers of a register file. The processor device additionally comprises means for performing a floating-point operation using the first floating-point value to generate a second floating-point value formatted according to the xqFP format. The processor device further comprises means for converting the second floating-point value to a floating-point output value formatted according to IEEE-754.

In another aspect, a method for storing floating-point values according to an xqFP format in processor devices is disclosed. The method comprises receiving, by an FPU circuit of a processor device, a floating-point input value formatted according to IEEE-754. The method further comprises converting, by the FPU circuit, the floating-point input value to a first floating-point value formatted according to the xqFP format, wherein the first floating-point value formatted according to the xqFP format comprises an exponent field and a significand field. The significand field is formatted as a signed one's complement value and comprises a sign bit, an explicit MSB, a fractional field, and a deferred increment bit that represents a value of one-half (½) ULP. The method also comprises storing, by the FPU circuit, the first floating-point value in a register of a plurality of registers of a register file of the processor device. The method additionally comprises performing, by the FPU circuit, a floating-point operation using the first floating-point value to generate a second floating-point value formatted according to the xqFP format. The method further comprises converting, by the FPU circuit, the second floating-point value to a floating-point output value formatted according to IEEE-754.

In another aspect, a non-transitory computer-readable medium is disclosed. The non-transitory computer-readable medium stores computer-executable instructions that, when executed, cause a processor device to receive a floating-point input value formatted according to IEEE-754. The computer-executable instructions further cause the processor device to convert the floating-point input value to a first floating-point value formatted according to an xqFP format, wherein the first floating-point value formatted according to the xqFP format comprises an exponent field and a significand field. The significand field is formatted as a signed one's complement value and comprises a sign bit, an explicit MSB, a fractional field, and a deferred increment bit that represents a value of one-half (½) ULP. The computer-executable instructions further also cause the processor device to store the first floating-point value in a register of a plurality of registers of a register file of the processor device. The computer-executable instructions additionally cause the processor device to perform a floating-point operation using the first floating-point value to generate a second floating-point value formatted according to the xqFP format. The computer-executable instructions further cause the processor device to convert the second floating-point value to a floating-point output value formatted according to IEEE-754.

### BRIEF DESCRIPTION OF THE FIGURES

FIGS. 1A and 1B are block diagrams illustrating exemplary floating-point number formats according to the Institute of Electrical and Electronics Engineers (IEEE) Standard for Floating-Point Arithmetic (IEEE-754) standard and the QFloat format, respectively;

FIG. 2 is a block diagram illustrating an exemplary floating-point number format according to an extended QFloat floating-point (xqFP) format disclosed herein, according to some aspects;

FIG. 3 is a block diagram of an exemplary processor-based device including an instruction processing circuit comprising a floating-point unit (FPU) circuit configured to store floating-point values according to the xqFP format, according to some aspects;

FIG. 4 is a diagram illustrating rounding to nearest odd and nearest even values using the xqFP format, according to some aspects;

FIGS. 5A and 5B provide a flowchart illustrating exemplary operations of the instruction processing circuit of FIG. 3 for storing floating-point values according to the xqFP format, according to some aspects; and

FIG. 6 is a block diagram of an exemplary processor-based device that can include the instruction processing circuit of FIG. 3.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects. The terms “first,” “second,” and the like used herein are intended to distinguish between similarly named elements, and do not indicate an ordinal relationship between such elements unless otherwise indicated.

Aspects disclosed in the detailed description include storing floating-point values according to an extended QFloat floating-point (xqFP) format in processor devices. Related apparatus and methods are also disclosed. In this regard, in some exemplary aspects disclosed herein, a processor device includes an instruction processing circuit that fetches, decodes, and executes computer-executable instructions in an instruction stream. The instruction processing circuit comprises a floating-point unit (FPU) circuit that is configured to store floating-point values according to an xqFP format. In exemplary operation, the FPU circuit of the processor device receives a floating-point input value formatted according to the Institute of Electrical and Electronics Engineers (IEEE) Standard for Floating-Point Arithmetic (IEEE-754) standard. The FPU circuit converts the floating-point input value to a floating-point value formatted according to the xqFP format, which comprises an exponent field and a significand field. The significand field is formatted as a signed one's complement value, and comprises a sign bit, an explicit most-significant bit (MSB), a fractional field, and a deferred increment bit that represents a value of one-half (½) unit of least precision (ULP). Some aspects may provide that the significand field further comprises a quarter-ULP bit that represents a value of one-fourth (¼) ULP.

In some aspects, the first floating-point value is unnormalized, and the explicit MSB indicates a value of an MSB of the first floating-point value. The first floating-point value according to some aspects may comprise one (1) of two (2) different representations: a first representation wherein the significand field stores a numeric value with the deferred increment bit set to a value of zero (0), and a second representation wherein the significand field stores the numeric value minus a value of one (1) with the deferred increment bit set to a value of one (1).

According to some aspects, converting the floating-point input value to the first floating-point value may comprise rounding the first floating-point value to a nearest even value (e.g., by determining whether the floating-point input value is nearest to but less than the nearest even value, and, if so, setting the deferred increment bit). Some aspects may provide that converting the floating-point input value to the first floating-point value may comprise the FPU circuit normalizing a subnormal value.

The FPU circuit is further configured to store the first floating-point value in a register of a plurality of registers of a register file of the processor device. The FPU circuit then performs a floating-point operation (e.g., a multiply operation, an addition operation, or a multiply-and-add operation, as non-limiting examples) using the first floating-point value to generate a second floating-point value formatted according to the xqFP format. In some aspects, performing the floating-point operation using the first floating-point value to generate the second floating-point value may comprise negating the first floating-point value by, e.g., performing a one's complement operation on the first floating-point value.

The FPU circuit converts the second floating-point value to a floating-point output value formatted according to the IEEE-754 standard. According to some aspects, converting the second floating-point value to the floating-point output value formatted according to IEEE-754 may comprise rounding the second floating-point value to a nearest odd value (e.g., by determining whether the rounded second floating-point value results in a tiebreaker value, and, if so, rounding the second floating-point value using the quarter-ULP bit to avoid a double-round error on a subsequent nearest-even-rounding operation). Some aspects in which the first floating-point value is a subnormal value may provide that converting the second floating-point value to the floating-point output value formatted according to IEEE-754 comprises converting the second floating-point value using the quarter-ULP bit to avoid a double-round error on a subsequent nearest-even-rounding operation.

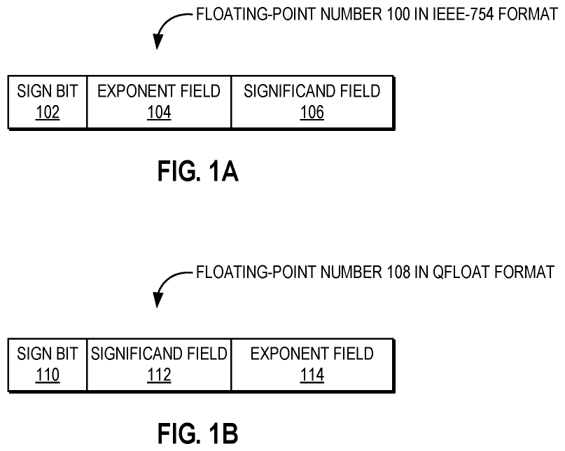

Before discussing the use of the xqFP format for representing and performing operations using floating-point values, floating-point formats according to the IEEE-754 standard and the QFloat format are first discussed with reference to FIGS. 1A and 1B, respectively. In FIG. 1A, an exemplary floating-point number 100 formatted according to the IEEE-754 standard is shown. The floating-point number 100 is represented by a sign bit 102, an exponent field 104 comprising a plurality of bits (not shown), and a significand field 106 comprising a plurality of bits (not shown). The sign bit 102 is a single bit that indicates a sign of the value stored in the significand field 106, with a value of zero (0) indicating a positive sign and a value of one (1) indicating a negative sign. The exponent field 104 stores a biased value representing a positive or negative exponent, while the significand field 106 stores a normalized value representing the significant digits of the floating-point number 100 as a binary fraction. Because the value of the significand field 106 is normalized, an implicit MSB having a value of one (1) is assumed for the significand field 106, which provides an extra bit of precision.

The IEEE-754 standard specifies particular combinations of the exponent field 104 and the significand field 106 to represent special values. A value of zero (0) (either positive or negative, depending on the value of the sign bit 102) is represented by both the exponent field 104 and the significand field 106 having a value of zero (0). Similarly, a value of infinity (either positive or negative, depending on the value of the sign bit 102) is represented by all bits of the exponent field 104 having a value of one (1) and the significand field 106 having a value of zero (0). A denormalized number (i.e., a floating-point value in which there is no implicit MSB having a value of one (1)) is represented by the exponent field 104 having a value of zero (0) and the significand field 106 having a non-zero value. Finally, a Not-a-Number (NaN) value (i.e., an error value) is represented by all bits of the exponent field 104 having a value of one (1) and the significand field 106 having a non-zero value.

As noted above the IEEE-754 standard defines arithmetic formats for floating-point values, and also specifies interchange formats, rounding rules, floating-point operations, and exception handling. However, implementing floating-point processing that is fully compliant with the IEEE-754 standard may be relatively expensive in terms of processor area and timing paths, and the requirement that floating-point numbers be normalized may require additional calculations and rounding operations to be performed. Accordingly, to enable floating-point processing in a more hardware-efficient manner, the QFloat format was developed. As shown in FIG. 1B, a floating-point number 108 formatted according to the QFloat format comprises a sign bit 110, a significand field 112 comprising a plurality of bits (not shown), and an exponent field 114 comprising a plurality of bits (not shown). The significand field 112 is formatted according to a two's complement fixed-point format that is MSB-aligned (i.e., no implied MSB), while the exponent field 114 is least-significant-bit (LSB)-aligned. The significand field 112 has an implied LSB with a value of one (1); consequently, rounding operations can be performed by truncating the LSB, but a value of absolute zero (0) is not representable using the QFloat format. QFloat values are rounded using Von Neumann rounding.

The QFloat format offers a number of benefits relative to the IEEE-754 standard's representation for floating-point numbers. Using the QFloat format, existing fixed-point data paths can be expanded to provide floating-point processing capability, providing a hardware-efficient solution. The QFloat format also provides less accuracy loss relative to the IEEE-754 standard, compared to other relatively hardware-efficient approaches. However, for applications that require full compliance with the IEEE-754 standard, the QFloat format may raise a number of issues. There are no special values defined in the QFloat format for infinity and NaN representations, due to tradeoffs made for the sake of simplicity and dynamic range. Moreover, the QFloat format's implied LSB having a value of one (1) introduces error to otherwise precise results, and the QFloat format is not able to represent an exact value of positive zero (+0) or negative zero (−0). In addition, the Von Neumann rounding used by the QFloat format causes different results at tiebreaker values compared to the IEEE-754 standard, and same-width subnormal products represented by the QFloat format underflow to a value of positive or negative tiniest value.

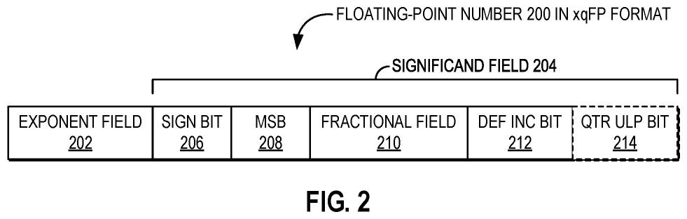

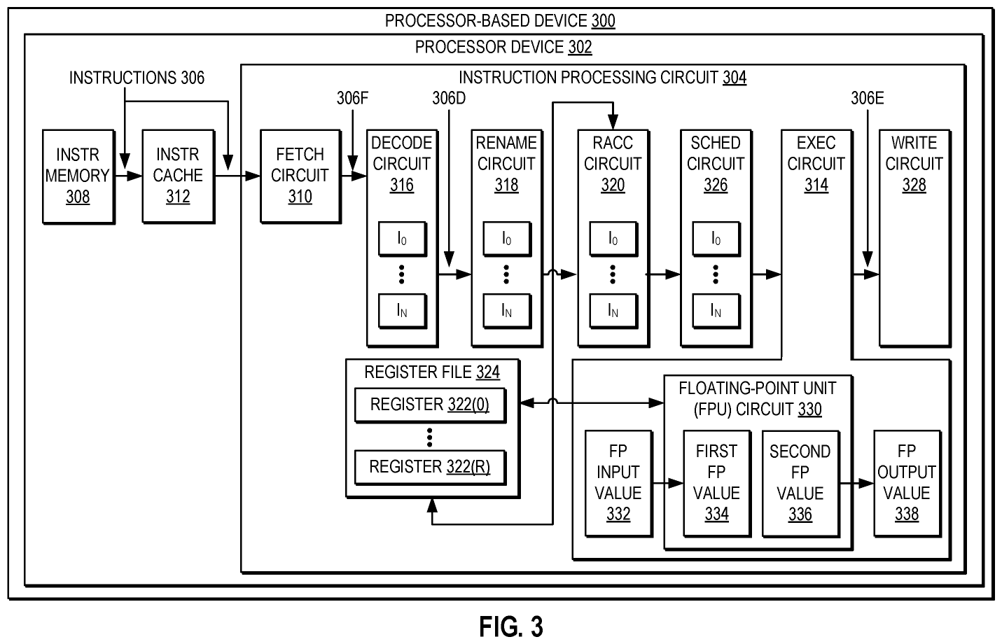

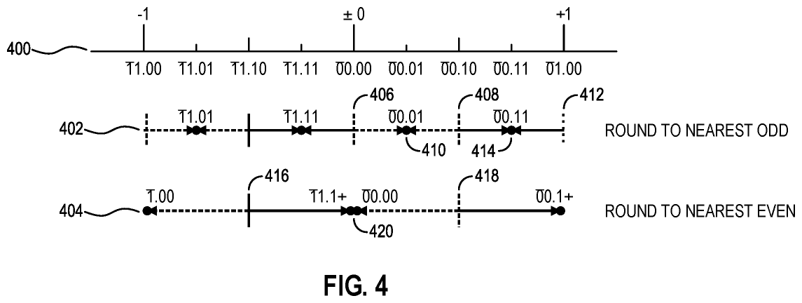

In this regard, FIG. 2 illustrates an exemplary floating-point number 200 formatted according to the xqFP format disclosed herein. The floating-point number 200 comprises an exponent field 202 and a significand field 204, which is formatted as a signed one's complement value. The significand field 204 comprises a sign bit 206, an explicit MSB (captioned as “MSB” in FIG. 2) 208, and a fractional field 210 that comprises a plurality of bits (not shown) representing a binary fraction. The sign bit 206 is a single bit that indicates a sign of the value stored in the fractional field 210, with a value of zero (0) indicating a positive sign and a value of one (1) indicating a negative sign. The exponent field 202 stores a biased value representing a positive or negative exponent, while the significand field 204 stores an unnormalized value representing the significant digits of the floating-point number 200. As the value of the significand field 204 is unnormalized, the explicit MSB indicates the value of the MSB for the significand field 204. The significand field 204 further includes a deferred increment bit (captioned as “DEF INC BIT” in FIG. 2) 212 that represents a value of ½ ULP, and, in some aspects, may also include a quarter-ULP bit (captioned as “QTR ULP BIT” in FIG. 2) 214 that represents a value of ¼ ULP. Operations and representations that are enabled by the xqFP format illustrated in FIG. 2 are discussed in greater detail below with respect to FIGS. 3 and 4.

FIG. 3 illustrates an exemplary processor-based device 300 that includes a processor device 302 configured to support the xqFP format for handling floating-point numbers. The processor device 302, which also may be referred to as a “processor core” or a “central processing unit (CPU) core,” may be an in-order or an out-of-order processor (OoP), and/or may be one of a plurality of processor devices 302 provided by the processor-based device 300. In the example of FIG. 3, the processor device 302 includes an instruction processing circuit 304 that includes one or more instruction pipelines I₀-I_{N} for processing a plurality of instructions 306 fetched from an instruction memory (captioned as “INSTR MEMORY” in FIG. 3) 308 by a fetch circuit 310 for execution. The instruction memory 308 may be provided in or as part of a system memory (not shown) in the processor-based device 300, as a non-limiting example. An instruction cache (captioned as “INSTR CACHE” in FIG. 3) 312 may also be provided in the processor device 302 to cache the instructions 306 fetched from the instruction memory 308 to reduce latency in the fetch circuit 310.

The fetch circuit 310 in the example of FIG. 3 is configured to provide the instructions 306 as fetched instructions 306F into the one or more instruction pipelines I₀-I_{N} in the instruction processing circuit 304 to be pre-processed, before the fetched instructions 306F reach an execution circuit (captioned as “EXEC CIRCUIT” in FIG. 3) 314 to be executed. The instruction pipelines I₀-I_{N} are provided across different processing circuits or stages of the instruction processing circuit 304 to pre-process and process the fetched instructions 306F in a series of steps that can be performed concurrently to increase throughput prior to execution of the fetched instructions 306F by the execution circuit 314.

With continuing reference to FIG. 3, the instruction processing circuit 304 includes a decode circuit 316 configured to decode the fetched instructions 306F fetched by the fetch circuit 310 into decoded instructions 306D to determine the instruction type and actions required. The instruction type and action required encoded in the decoded instructions 306D may also be used to determine in which instruction pipeline I₀-I_{N} the decoded instructions 306D should be placed. In this example, the decoded instructions 306D are placed in one or more of the instruction pipelines I₀-I_{N} and are next provided to a rename circuit 318 in the instruction processing circuit 304. The rename circuit 318 is configured to determine if any register names in the decoded instructions 306D should be renamed to decouple any register dependencies that would prevent parallel or out-of-order processing.

The instruction processing circuit 304 in the processor device 302 in FIG. 3 also includes a register access circuit (captioned as “RACC CIRCUIT” in FIG. 3) 320. The register access circuit 320 is configured to access a register of a plurality of registers 322(0)-322(R) in a register file 324 based on a mapping entry mapped to a logical register in a register mapping table (RMT) (not shown) of a source register operand of a decoded instruction 306D to retrieve a produced value from an executed instruction 306E in the execution circuit 314. The register access circuit 320 is also configured to provide the retrieved produced value from an executed instruction 306E as the source register operand of a decoded instruction 306D to be executed.

Also, in the instruction processing circuit 304, a scheduler circuit (captioned as “SCHED CIRCUIT” in FIG. 3) 326 is provided in the instruction pipeline I₀-I_{N} and is configured to store decoded instructions 306D in reservation entries until all source register operands for the decoded instruction 306D are available. The scheduler circuit 326 issues decoded instructions 306D that are ready to be executed to the execution circuit 314. A write circuit 328 is also provided in the instruction processing circuit 304 to write back or commit produced values from executed instructions 306E (e.g., to the register file 324, to cache memory, or to system memory).

As seen in FIG. 3, the execution circuit 314 of the instruction processing circuit 304 comprises an FPU circuit 330 that is configured to perform floating-point operations, and, in particular, to store floating-point values according to the xqFP format. In exemplary operation, the FPU circuit 330 of the processor device 302 receives a floating-point input value (captioned as “FP INPUT VALUE” in FIG. 3) 332 formatted according to IEEE-754. The FPU circuit 330 converts the floating-point input value 332 to the first floating-point value (captioned as “FIRST FP VALUE” in FIG. 3) 334 formatted according to the xqFP format. In some aspects, an xqFP datapath (not shown) provided the FPU circuit 330 may be based on a fixed-point datapath circuit (not shown), with additional circuitry to convert the floating-point input value 332 to the first floating-point value 334 by performing bit-shifting operations as needed. As noted above with respect to FIG. 2, the first floating-point value 334 formatted according to the xqFP format comprises an exponent field such as the exponent field 202 of FIG. 2, and a significand field such as the significand field 204 of FIG. 2. Exemplary formats of different xqFP data types are illustrated and discussed in greater detail below with respect to Table 1.

In some aspects, the first floating-point value 334 is unnormalized, and an explicit MSB (e.g., the explicit MSB 208 of FIG. 2) indicates a value of an MSB of the first floating-point value 334. According to some aspects, the first floating-point value 334 may comprise one of a first representation and a second representation, wherein the first representation comprises the significand field 204 storing a numeric value with the deferred increment bit 212 set to a value of zero (0), and the second representation comprises the significand field 204 storing the numeric value minus a value of one (1) with the deferred increment bit 212 set to a value of one (1).

In some aspects, converting the floating-point input value 332 to the first floating-point value 334 may comprise rounding the first floating-point value 334 to a nearest even value. Some such aspects may provide that rounding the first floating-point value 334 to the nearest even value comprises the FPU circuit 330 determining whether the floating-point input value 332 is nearest to but less than the nearest even value, and, if so, setting the deferred increment bit 212. Rounding xqFP floating-point numbers to nearest even values are illustrated and discussed in greater detail below with respect to FIG. 4 and Tables 9-10. According to some aspects, converting the floating-point input value 332 to the first floating-point value 334 may comprise the FPU circuit 330 normalizing a subnormal value.

The FPU circuit 330 next stores the first floating-point value 334 in a register, such as the register 322(0), of the plurality of registers 322(0)-322(R) of the register file 324. The FPU circuit 330 then performs a floating-point operation using the first floating-point value 334 to generate a second floating-point value (captioned as “SECOND FP VALUE” in FIG. 3) 336 formatted according to the xqFP format. Operations that the FPU circuit 330 may be configured to perform to accomplish different floating-point operations using the xqFP format in some aspects are discussed in greater detail below with respect to Table 2. In some aspects, performing the floating-point operation using the first floating-point value 334 to generate the second floating-point value 336 may comprise negating the first floating-point value 334 (i.e., by performing a one's complement operation on the first floating-point value 334).

The FPU circuit 330 subsequently converts the second floating-point value 336 to a floating-point output value (captioned as “FP OUTPUT VALUE” in FIG. 3) 338 formatted according to IEEE-754 (e.g., in response to execution of an explicit convert instruction (not shown)). According to some aspects, converting the second floating-point value 336 to the floating-point output value 338 formatted according to IEEE-754 comprises rounding the second floating-point value 336 to a nearest odd value. In some such aspects, rounding the second floating-point value 336 to the nearest odd value may comprise the FPU circuit 330 determining whether the rounded second floating-point value 336 results in the tiebreaker value. If so, the FPU circuit 330 rounds the second floating-point value 336 using a quarter-ULP bit (such as the quarter-ULP bit 214 of FIG. 2) to avoid a double-round error on a subsequent nearest-even-rounding operation. Rounding xqFP floating-point numbers to nearest odd values are illustrated and discussed in greater detail below with respect to FIG. 4 and Tables 9-10.

Some aspects in which the first floating-point value 334 is a subnormal value may provide that converting the second floating-point value 336 to the floating-point output value 338 formatted according to IEEE-754 comprises converting the second floating-point value 336 using the quarter-ULP bit 214 to avoid a double-round error on a subsequent nearest-even-rounding operation. The use of the quarter-ULP bit 214 to avoid double-round errors are discussed in greater detail below with respect to Table 10.

Table 1 below illustrates characteristics of the xqFP 16-bit floating-point data type (“qf16”) and the xqFP 32-bit floating-point data type (“qf32”) compared to the conventional 16-bit half-precision floating-point data type (“hf”) and the conventional 32-bit single-precision floating-point data type (“sf”), according to some aspects:

TABLE 1

| | | | | | Max | Min | |
|---|---|---|---|---|---|---|---|
| | | Exponent | Pre- | Inexact | Exp | Exp | Non- |
| Type | Signed | Bits | cision | Indicator | eₘₐₓ | eₘᵢₙ | finites |
| hf | 1 | 5 | 11 | 0 | 15 | −14 | ±inf, nan |
| qf16 | 1 | 5 | 11 | 0 | 15 | −15 | ±inf, nan |
| sf | 1 | 8 | 24 | 0 | 127 | −126 | ±inf, nan |
| qf32 | 1 | 9 | 24 | 1 | 255 | −255 | ±inf, nan |

As seen in Table 1, the xqFP data types have a smaller minimum exponent (“eₘᵢₙ”) due to an explicit integral bit. Additionally, the qf32 data type includes an extra exponent bit that enables handling of subnormal values and defers overflows. Finally, the qf32 data type includes an inexact indicator that corresponds to the IEEE-754 standard's inexact exception, but is included as part of each qf32 floating-point value. The inexact indicator may be used to eliminate double-round errors when rounding to a reduced precision or to a subnormal value.

Table 2 below illustrates operations that the FPU circuit 330 may be configured to perform to accomplish different floating-point operations using the xqFP format, according to some aspects. Note that these operations rely on the feature that, that for a given xqFP floating-point value X, the following is true: −X=˜X+1; X+1=−(˜X); and −(X+1)=−X=(−X−1).

TABLE 2

| | | | Add | | | |
|---|---|---|---|---|---|---|
| | | | (rNE/rU/ | Add | | |
| | | Multiply | rZ) | (rD) | Sub | |
| | | opposite | both | either | (rNE/rU/ | Sub |
| A | B | neg/inc | neg/inc | neg/inc | rZ) | (rD) |
| A | B | A * B | A + B | A + B | A + ~B + | −(~A + |
| | | | | | 1 | B + 1) |
| A | −B | −(A * B) | A + ~B + | −(~A + | A + B | A + B |
| | | | 1 | B + 1) | | |
| A | B + 1 | −(A * | A + B + 1 | −(~A + | A + ~B | A + ~B |
| | | ~B) | | ~B + 1) | | |
| −A | B | −(A * B) | ~A + B + | −(A + | −(A + B) | −(A + B) |
| | | | 1 | ~B + 1) | | |
| −A | −B | A * B | −(A + B) | −(A + B) | ~A + B + | −(A + |
| | | | | | 1 | ~B + 1) |
| −A | B + 1 | A * ~B | −(A + ~B) | −(A + ~B) | ~A + | −(A + B + |
| | | | | | ~B + 1 | 1) |
| A + 1 | B | −(~A * | A + B + 1 | −(~A + | −(~A + | −(~A + B) |
| | | B) | | ~B +1) | B) | |
| A + 1 | −B | ~A * B | −(~A + B) | −(~A + B) | A + B + | −(~A + |
| | | | | | 1 | ~B + 1) |
| A + 1 | B + 1 | ~A * ~B | −(~A + | −(~A + | A + ~B + | −(~A + |
| | | | ~B) | ~B) | 1 | B + 1) |

Table 3 below illustrates the effects of normalization of inputs on xqFP floating-point output values generated by the FPU circuit 330:

TABLE 3

| | Both | Larger | Smaller | Neither |
|---|---|---|---|---|
| | inputs | input | input | input |
| Operation | normalized | normalized | normalized | normalized |
| Multiplication | Normalized | Accuracy | Accuracy | Accuracy |
| | <min- | loss | loss | loss |
| | normal→0 | | | |
| Near effective | Normalized | Normalized | Normalized | Precise |
| addition | | | | |
| Far effective | Normalized | Normalized | Normalized | Normalized |
| addition | | | | or Precise |
| Near effective | Precise | Precise | Precise | Precise |
| subtraction | | | | |
| Far effective | Normalized | Normalized | Normalized | Normalized |
| subtraction | | | | or Precise |

In most cases with normalized inputs, the FPU circuit 330 can generate normalized outputs by performing a one (1)-bit shift, based on overflow indicated by an arithmetic logic unit (ALU) circuit (not shown) of the execution circuit 314 of FIG. 3. The FPU circuit 330 in some aspects may maintain precision and generate more normalized output values by normalizing (i.e., performing bitwise left-shift operations on) a larger input value in parallel with aligning (i.e., performing bitwise right-shift operations on) a smaller input value. In other cases, a precise (but not necessarily normalized) output value relative to input values may be generated for addition and subtraction operations. It is noted that, when the natural product exponent is less than the minimum exponent, the result will underflow to a value of zero (0). An extra exponent bit may be provided for xqFP 32-bit floating-point values to avoid such underflow with IEEE-754 range (i.e., values that would be subnormal under the IEEE-754 32-bit floating-point format are normalized in the xqFP format). Note further that, without normalized input values, multiplication operations result in an error of at most ½ ULP on each unnormal input value. Normalization is needed when an input value is not normalized to achieve IEEE-754 precision.

Table 4 below illustrates exemplary sequences of operations that may be applied by the FPU circuit 330 according to some aspects to generate IEEE-754-compliant single-precision floating-point output values based on single-precision floating-point input values:

TABLE 4

| | | | | | Exponent |
|---|---|---|---|---|---|
| | | | | | before |
| | | | | Normalized | rounding/ |
| | | IEEE-754 | Impact of | (X.exp==└log2 | overflow/ |
| Type | Operation | purpose | skipping | (\|X\|)┘) when | underflow |
| sf | A | input | — | A.exp>sf.emin | └log₂(\|A\|)┘ |
| | | operand | | | |
| sf | B | input | — | B.exp>sf.emin | └log₂(\|B\|)┘ |
| | | operand | | | |
| qf32 | Z | +zero=0*0 | — | False | qf32.emin |
| | | for | | | |
| | | normalization | | | |
| sf | Y = A + B | reference | — | Y.exp>sf.emin | └log₂(\|A+B\|)┘ |
| | | operation | | | |
| qf32 | Y0 = A + B | native | — | (A.exp== | max(max(A.exp, |
| | | operation | | └log₂(\|A\|)┘ \|\| | B.exp)−(A*B<0), |
| | | | | B.exp== | min(A.exp, |
| | | | | └log₂(\|B\|)┘) && | B.exp)) |
| | | | | (A*B>0 \|\| \|A.exp- | |
| | | | | B.exp\|>1) | |
| sf | Y = Y0 | overflow | no | Y.exp>sf.emin | └log₂(\|Y0\|)┘ |
| | | to smaller | overflow | | |
| | | sf.emax | | | |
| sf | Y = A − B | reference | — | Y.exp>sf.emin | └log₂(\|A−B\|)┘ |
| | | operation | | | |
| qf32 | Y0 = A − B | native | — | (A.exp== | max(max(A.exp, |
| | | operation | | └log₂(\|A\|)┘ \|\| | B.exp)−(A*B>0), |
| | | | | B.exp== | min(A.exp, |
| | | | | └log₂(\|B\|)┘) && | B.exp)) |
| | | | | (A*B<0 \|\| | |
| | | | | \|A.exp−B.exp\|>1) | |
| sf | Y = Y0 | overflow | no | Y.exp>sf.emin | └log₂(\|Y0\|)┘ |
| | | to smaller | overflow | | |
| | | sf.emax | | | |
| sf | Y = A * B | reference | — | Y.exp>sf.emin | └log₂(\|A*B\|)┘ |
| | | operation | | | |
| qf32 | A1 = A − Z | normalize | A | A!= 0 | └log₂(\|A\|)┘ |
| | | subnormals | subnormal: | | |
| | | | <=+½ | | |
| | | | ULP error | | |
| qf32 | B1 = B − Z | normalize | B | B!= 0 | └log₂(\|B\|)┘ |
| | | subnormals | subnormal: | | |
| | | | <=+½ | | |
| | | | ULP error | | |
| qf32 | Y0 = A1 * B1 | native | — | A1.exp== | A.exp+B.exp |
| | | operation | | └log₂(\|A1\|)┘ && | |
| | | | | B1.exp== | |
| | | | | └log₂(\|B1\|)┘ | |
| sf | Y = Y0 | over-/ | no over-/ | Y.exp>sf.emin | └log₂(\|Y0\|)└ |
| | | under- | under- | | |
| | | flow to sf | flow | | |
| | | range | | | |

Similarly, Table 5 below illustrates exemplary sequences of operations that may be applied by the FPU circuit 330 according to some aspects to generate IEEE-754-compliant single-precision floating-point output values based on xqFP 32-bit floating-point input values:

TABLE 5

| | | | | | Exponent |
|---|---|---|---|---|---|
| | | | | | before |
| | | | Impact of | Normalized | rounding/ |
| | | IEEE-754 | skipping | (X.exp== | overflow/ |
| Type | Operation | purpose | (aliasing) | └log2(\|X\|)┘) when | underflow |
| qf32 | A | input | — | A.exp== | Any |
| | | operand | | └log₂(A)┘ | |
| qf32 | B | input | — | B.exp== | Any |
| | | operand | | └log₂(B)┘ | |
| qf32 | Z | +zero=0*0 | — | False | qf32.emin |
| | | for | | | |
| | | normalization | | | |
| sf | Y = A + B | reference | — | Y.exp>sf.emin | └log₂ |
| | | operation | | | (\|A+B\|)┘ |
| qf32 | Y = A + B | operation in | — | (A.exp== | max(└log₂ |
| | | larger qf32 | | └log₂(\|A\|)┘ \|\| | (\|max(A,B)\|)┘− |
| | | range | | B.exp== | (A*B<0), |
| | | | | └log₂(\|B\|)┘) && | min(A.exp, |
| | | | | (A*B>0 \|\| | B.exp)) |
| | | | | └log₂(\|max(A,B)\|)┘− | |
| | | | | min(A.exp,B.exp)> | |
| | | | | 1) | |
| sf | Y = A − B | reference | — | Y.exp>sf.emin | └log₂(\|A−B\|)┘ |
| | | operation | | | |
| qf32 | Y = A − B | operation in | — | (A.exp== | max(└log₂ |
| | | larger qf32 | | └log₂(\|A\|)┘ \|\| | (\|max(A,B)\|)┘− |
| | | range | | B.exp== | (A*B>0), |
| | | | | └log₂(\|B\|)┘) && | min(A.exp, |
| | | | | (A*B<0 \|\| | B.exp)) |
| | | | | └log₂(\|max(A,B)\|)┘− | |
| | | | | min(A.exp,B.exp)> | |
| | | | | 1) | |
| sf | Y = A * B | reference | — | Y.exp>sf.emin | └log₂(\|A*B\|)┘ |
| | | operation | | | |
| qf32 | A1 = A − Z | normalize | A | A.exp>qf32.emin | └log₂(\|A\|)┘ |
| | | unnormals | unnormal: | | |
| | | | <=+½ ULP | | |
| | | | error | | |
| qf32 | B1 = B − Z | normalize | B | B.exp>qf32.emin | └log₂(\|B\|)┘ |
| | | unnormals | unnormal: | | |
| | | | <=+½ ULP | | |
| | | | error | | |
| qf32 | Y = A1 * B1 | native | — | A1.exp== | A1.exp+ |
| | | operation | | └log₂(\|A1\|)┘ && | B1.exp |
| | | underflow | | B1.exp== | |
| | | (<qf32.emi | | └log₂(\|B1\|)┘ | |
| | | n) to 0 | | | |

Table 6 below illustrates exemplary sequences of operations that may be applied by the FPU circuit 330 according to some aspects to generate IEEE-754-compliant half- or single-precision floating-point output values based on half-precision floating-point input values:

TABLE 6

| | | | | Exponent before |
|---|---|---|---|---|
| | | | Normalized | rounding/ |
| | | IEEE-754 | (X.exp==└log2(\|X\|)┘) | overflow/ |
| Type | Operation | purpose | when | underflow |
| hf | A | input operand | A.exp>hf.emin | └log₂(\|A\|)┘ |
| hf | B | input operand | A.exp>hf.emin | └log₂(\|B\|)┘ |
| hf | Y = A + B | reference | Y.exp>hf.emin | └log₂(\|A+B\|)┘ |
| | | operation | | |
| qf16 | Y = A + B | compliant | (A.exp==└log₂(\|A\|)┘ \|\| | max(max(A.exp, |
| | | operation | B.exp==└log₂(\|B\|)┘) | B.exp)−(A*B<0), |
| | | | && | min(A.exp,B.exp)) |
| | | | (A*B>0 \|\| \|A.exp− | |
| | | | B.exp\|>1) | |
| hf | Y = A − B | reference | Y.exp>sf.emin | └log₂(\|A−B\|)┘ |
| | | operation | | |
| qf16 | Y = A − B | compliant | (A.exp==└log₂(\|A\|)┘ \|\| | max(max(A.exp, |
| | | operation | B.exp==└log₂(\|B\|)┘) | B.exp)−(A*B>0), |
| | | | && | min(A.exp,B.exp)) |
| | | | (A*B<0 \|\| \|A.exp− | |
| | | | B.exp\|>1) | |
| hf | Y = A * B | reference | Y.exp>hf.emin | └log₂(\|A*B\|)┘ |
| | | operation | | |
| qf32 | Y0 = A * B | precise | A.exp==└log₂(\|A\|)┘ | A.exp+B.exp |
| | | operation | && B.exp==└log₂(\|B\|)┘ | |
| hf | Y = Y0 | over-/under- | Y.exp>sf.emin | └log₂(\|Y0\|)┘ |
| | | flow to hf | | |
| | | range | | |
| qf16 | Y = A * B | compliant for | A.exp==└log₂(\|A\|)┘ | A.exp+B.exp |
| | | normal | && B.exp==└log₂(\|B\|)┘ | |
| | | operands | | |
| | | subnormal | | |
| | | inputs: <=+½ | | |
| | | ULP error | | |
| | | exponent | | |
| | | underflows | | |
| | | yield 0 | | |
| sf | Y = A * B | reference | Y.exp>hf.emin | └log₂(\|A*B\|)┘ |
| | | (precise) | | |
| | | operation | | |
| qf32 | Y = A * B | precise | A.exp==└log₂(\|A\|)┘ | A.exp+B.exp |
| | | operation | && B.exp==└log₂(\|B\|)┘ | |

Likewise, Table 7 below illustrates exemplary sequences of operations that may be applied by the FPU circuit 330 according to some aspects to generate IEEE-754-compliant half-precision floating-point output values based on xqFP 16- or 32-bit floating-point input values:

TABLE 7

| | | | | Exponent before |
|---|---|---|---|---|
| | | | Normalized | rounding/ |
| | | IEEE-754 | (X.exp==└log2(X)┘) | overflow/ |
| Type | Operation | purpose | when | underflow |
| qf16 | A | input | A.exp==└log₂(\|A\|)┘ | Any |
| | | operand | | |
| qf16 | B | input | B.exp==└log₂(\|B\|)┘ | Any |
| | | operand | | |
| hf | Y = A + B | reference | Y.exp>hf.emin | └log₂(\|A+B\|)┘ |
| | | operation | | |
| qf16 | Y = A + B | compliant | (A.exp==└log₂(\|A\|)┘ \|\| | max(└log₂(\|max(A,B)\|)┘− |
| | | operation | B.exp==└log₂(\|B\|)┘) && | (A*B<0), |
| | | | (A*B>0 \|\| | min(A.exp,B.exp)) |
| | | | └log₂(\|max(A,B)\|)┘− | |
| | | | min(A.exp,B.exp)>1) | |
| hf | Y = A − B | reference | Y.exp>hf.emin | └log₂(\|A−B\|)┘ |
| | | operation | | |
| qf16 | Y = A − B | compliant | (A.exp==└log₂(\|A\|)┘ \|\| | max(└log₂(\|max(A,B)\|)┘− |
| | | operation | B.exp==└log₂(\|B\|)┘) && | (A*B>0), |
| | | | (A*B<0 \|\| | min(A.exp,B.exp)) |
| | | | └log₂(\|max(A,B)\|)┘− | |
| | | | min(A.exp,B.exp)>1) | |
| hf | Y = A * B | reference | Y.exp>hf.emin | └log₂(\|A*B\|)┘ |
| | | operation | | |
| qf32 | Y0 = A * B | precise | A.exp==└log₂(\|A\|)┘ && | A.exp+B.exp |
| | | operation | B.exp==└log₂(\|B\|)┘ | |
| qf16 | Y = A * B | compliant | A.exp==└log₂(\|A\|)┘ && | A.exp+B.exp |
| | | for normal | B.exp==└log₂(\|B\|)┘ && | |
| | | operands | A.exp+B.exp>qf16.emin | |
| | | unnormal | | |
| | | inputs: | | |
| | | <=+½ | | |
| | | ULP error | | |
| | | exponent | | |
| | | underflows | | |
| | | yield 0 | | |
| sf | Y = A * B | reference | Y.exp>hf.emin | └log₂(\|A*B\|)┘ |
| | | (precise) | | |
| | | operation | | |
| qf32 | Y = A * B | precise | A.exp==└log₂(\|A\|)┘ && | A.exp+B.exp |
| | | operation | B.exp==└log₂(\|B\|)┘ | |

Table 8 below illustrates native multiply behavior for all input and output types (with potentially unnormal inputs) of the FPU circuit 330 according to some aspects:

TABLE 8

| A=A.sig*2^{A.exp} | B=B.sig*2^{B.exp} | IEEE-754 equivalent |
|---|---|---|
| \|sig\|≥1 (normal) | \|sig\|≥1 (normal) | A*B=[((2^{A.exp}*A.sig)*(B.sig*2^{B.exp}))] |
| exp=emin | \|sig\|≥1 (normal) | [(2^{A.exp}*A.sig*B.sig)*2^{B.exp}] |
| (subnormal) | | |
| \|sig\|≥1 (normal) | exp=emin (subnormal) | [2^{A.exp}*(A.sig*B.sig*2^{B.exp})] |
| * | * | [(A.sig*B.sig*2^{emin}) *2^{A.exp+B.exp-emin}] |

Mathematically, unrounded results are the same, while with rounded results, the difference relates to associativity and rounding of the intermediate product. In general, significands are multiplied and rounded without normalizing, and then scaled using the exponent sum. Scaling the significand product to an exponent of eₘᵢₙ effectively prevents normalization with IEEE arithmetic. The result underflows to ±0 when the exponent sum is less than qf.eₘᵢₙ. Because the qf32 data format has much smaller eₘᵢₙ, underflow does not happen when calculating the product of two sf data values. However, the qf16 data format has only a slightly smaller eₘᵢₙ, so many fp16 subnormal results will underflow to a value of zero (0). Note that a subnormal input with the other operand being less than 2.0 results in an IEEE-754-compliant value of A*B after converting back to IEEE-754 (assuming no exponent underflow).

As noted above with respect to FIG. 3, the FPU circuit 330 may be configured to round the first floating-point value 334 to a nearest even value, and may be further configured to round the second floating-point value 336 to a nearest odd value. In this regard, FIG. 4 illustrates how the FPU circuit 330 of FIG. 3 may handle rounding to nearest odd and nearest even floating-point values according to some aspects. In FIG. 4, a number line 400 shows a range of floating-point values (in xqFP format) between negative one (−1) and one (1). Below the number line 400 are lines 402 and 404 that illustrate how values that fall within different bounded ranges are rounded when rounding to nearest odd values and to nearest even values, respectively. Tiebreaker values (i.e., values equidistant from potential odd- or even-rounded values) are indicated with vertical lines, while the result of rounding for each tiebreaker value is indicated with an arrow of the same type (i.e., solid or dotted line) as the tiebreaker value. Thus, for example, when rounding to nearest odd values, binary values between tiebreaker values 406 and 408, inclusive, are rounded to a nearest odd value 410, while values between tiebreaker values 408 and 412, excluding the tiebreaker values 408 and 412 themselves, are rounded to a nearest odd value 414. Similarly, when rounding to nearest even values, values between tiebreaker values 416 and 418, inclusive, are rounded to a nearest even value 420. Note that in the latter case, the nearest even value 420 having a value of zero (0), may be represented in the xqFP format as either 1̅1.1+(i.e., a floating-point value in the xqFP format with the deferred increment bit 212 set) or as the value 0̅0.00 (i.e., a floating-point value in the xqFP format with the deferred increment bit 212 not set).

Table 9 illustrates the use by the FPU circuit 330 of FIG. 3 of an LSB (captioned “L” in Table 9) of the fractional field 210 of FIG. 2 and the deferred increment bit 212 of FIG. 2 (captioned “R” in Table 9) to represent precise floating-point values in the xqFP format to when rounding to nearest even values (captioned “NE” in Table 9), according to some aspects:

TABLE 9

| Value Before Round | L | R | NE |
|---|---|---|---|
| 0.0 | 0 | 0 | 0 |
| (0, 0.5) | 0 | 0 | 0 |
| 0.5 | 0 | 0 | 0 |
| (0.5, 1.0) | 0 | 1 | 1 |
| 1.0 | 1 | 0 | 1 |
| (1.0, 1.5) | 1 | 0 | 1 |
| 1.5 | 1 | 1 | 2 |
| (1.5, 2.0) | 1 | 1 | 2 |

Table 10 illustrates the use by the FPU circuit 330 of FIG. 3 of an LSB (captioned “L” in Table 10) of the fractional field 210 of FIG. 2, the deferred increment bit 212 of FIG. 2 (captioned “R” in Table 10), and the quarter-ULP bit 214 of FIG. 2 (captioned “Q” in Table 10) to represent precise floating-point values in the xqFP format to avoid double-rounding errors, according to some aspects. In particular, Table 10 shows ways in which the FPU circuit 330 can interpret the values of the deferred increment bit 212 and the quarter-ULP bit 214 when performing subsequent nearest-even-rounding operations in such aspects.

TABLE 10

| Before | | | | | | | L + R/2 + Q/ | L + R + |
|---|---|---|---|---|---|---|---|---|
| round | L | R | Q | L + R | L + R/2 + ¼ | L + (R + Q)/2 | 4 + ⅛ | (Q − R)/4 |
| 0.000 | 0 | 0 | 0 | 0.00 | 0.25 | 0.00 | 0.125 | 0.00 |
| (0, 0.5) | 0 | 0 | 1 | 0.00 | 0.25 | 0.50 | 0.375 | 0.25 |
| 0.500 | 0 | 0 | 1 | 0.00 | 0.25 | 0.50 | 0.375 | 0.25 |
| (0.5, 1) | 0 | 1 | 0 | 1.00 | 0.75 | 0.50 | 0.625 | 0.75 |
| 1.000 | 0 | 1 | 1 | 1.00 | 0.75 | 1.00 | 0.875 | 1.00 |
| 1.000 | 1 | 0 | 0 | 1.00 | 1.25 | 1.00 | 1.125 | 1.00 |
| (1.0, 1.5) | 1 | 0 | 1 | 1.00 | 1.25 | 1.50 | 1.375 | 1.25 |
| 1.500 | 1 | 1 | 0 | 2.00 | 1.75 | 1.50 | 1.625 | 1.75 |
| (1.5, 2.0) | 1 | 1 | 0 | 2.00 | 1.75 | 1.50 | 1.625 | 1.75 |
| 2.000 | 1 | 1 | 1 | 2.00 | 1.75 | 2.00 | 1.875 | 2.00 |

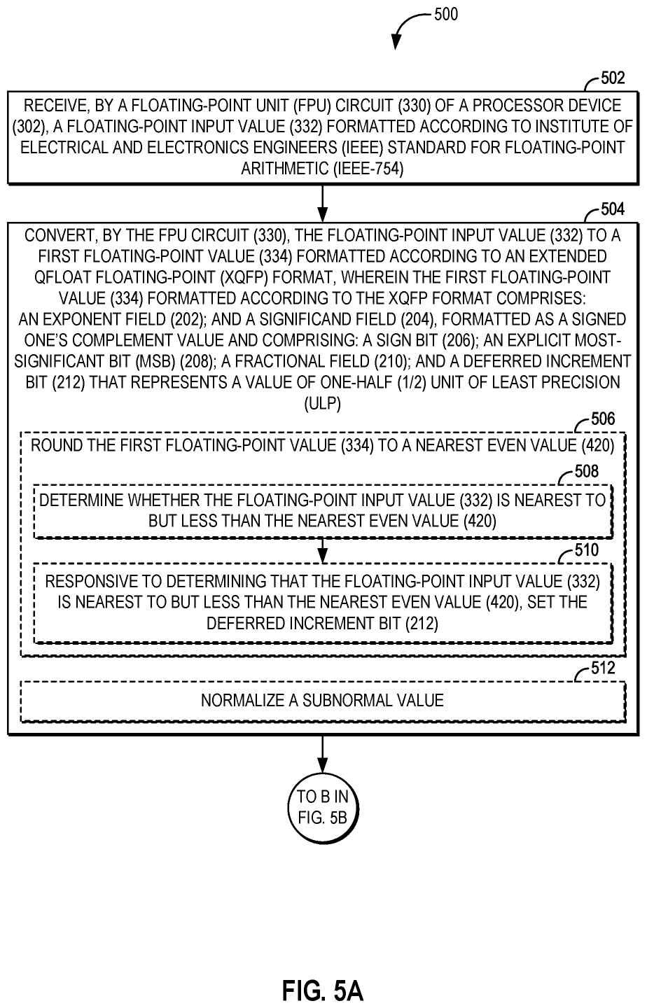

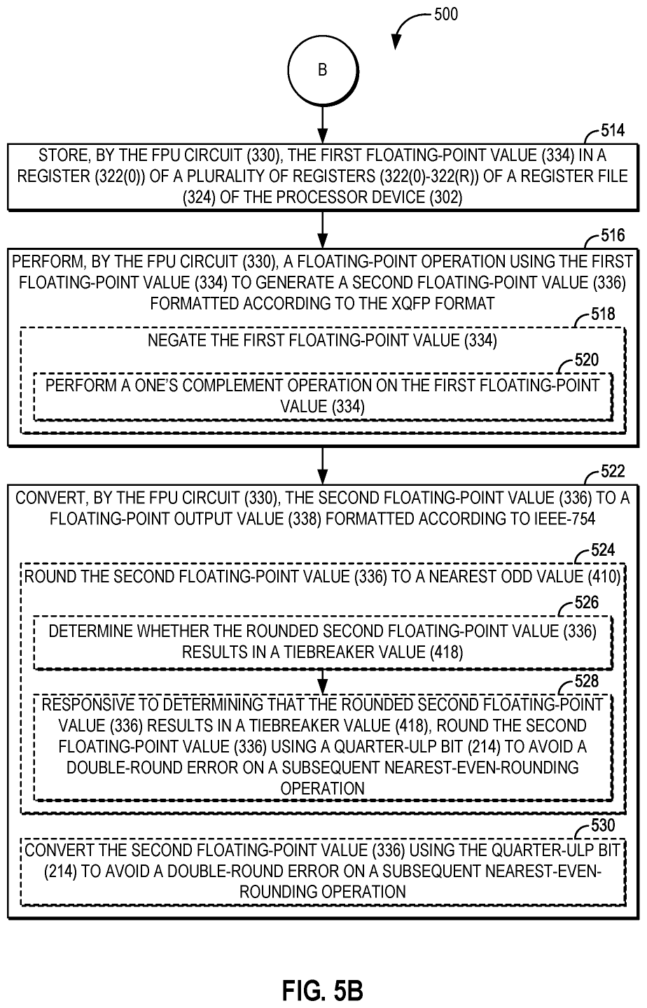

To illustrate operations performed by the instruction processing circuit 304 of FIG. 3 for storing floating-point values according to the xqFP format according to some aspects, FIGS. 5A and 5B provide a flowchart showing exemplary operations 500. For the sake of clarity, elements of FIGS. 2-4 are referenced in describing FIGS. 5A and 5B. It is to be understood that some aspects may provide that some operations illustrated in FIGS. 5A and 5B may be performed in an order other than that illustrated herein, and/or may be omitted.

The exemplary operations 500 begin in FIG. 5A with an FPU circuit of a processor device (e.g., the FPU circuit 330 of the processor device 302 of FIG. 3) receiving a floating-point input value (such as the floating-point input value 332 of FIG. 3) formatted according to IEEE-754 (block 502). The FPU circuit 330 converts the floating-point input value 332 to a first floating-point value (e.g., the first floating-point value 334 of FIG. 3) formatted according to an xqFP format (block 504). The first floating-point value 334 formatted according to the xqFP format comprises an exponent field (such as the exponent field 202 of FIG. 2), and a significand field (e.g., the significand field 204 of FIG. 2). The significand field 204 is formatted as a signed one's complement value and comprises a sign bit (such as the sign bit 206 of FIG. 2), an explicit MSB (e.g., the explicit MSB 208 of FIG. 2), a fractional field (such as the fractional field 210 of FIG. 2), and a deferred increment bit (e.g., the deferred increment bit 212 of FIG. 2) that represents a value of one-half (½) ULP.

In some aspects, the operations of block 504 for converting the floating-point input value 332 to the first floating-point value 334 may comprise rounding the first floating-point value 334 to a nearest even value (such as the nearest even value 420 of FIG. 4) (block 506). Some such aspects may provide that the operations of block 506 for rounding the first floating-point value 334 to the nearest even value 420 comprise the FPU circuit 330 determining whether the floating-point input value 332 is nearest to but less than the nearest even value 420 (block 508). If so, the FPU circuit 330 may set the deferred increment bit 212 (block 510). According to some aspects, the operations of block 504 for converting the floating-point input value 332 to the first floating-point value 334 may comprise the FPU circuit 330 normalizing a subnormal value (block 512). The exemplary operations 500 then continue at block 514 of FIG. 5B.

Referring now to FIG. 5B, the FPU circuit 330 next stores the first floating-point value 334 in a register of a plurality of registers of a register file (e.g., the register 322(0) of the plurality of registers 322(0)-322(R) of the register file 324 of FIG. 3) of the processor device 302 (block 514). The FPU circuit 330 then performs a floating-point operation using the first floating-point value 334 to generate a second floating-point value (such as the second floating-point value 336 of FIG. 2) formatted according to the xqFP format (block 516). In some aspects, the operations of block 516 for performing the floating-point operation using the first floating-point value 334 to generate the second floating-point value 336 may comprise negating the first floating-point value 334 (block 518). Some such aspects may provide that the operations of block 518 for negating the first floating-point value 334 comprise the FPU circuit 330 performing a one's complement operation on the first floating-point value 334 (block 520).

The FPU circuit 330 converts the second floating-point value 336 to a floating-point output value (e.g., the floating-point output value 338 of FIG. 2) formatted according to IEEE-754 (block 522). According to some aspects, the operations of block 522 for converting the second floating-point value 336 to the floating-point output value 338 formatted according to IEEE-754 comprises rounding the second floating-point value 336 to a nearest odd value (such as the nearest odd value 410 of FIG. 4) (block 524). In some such aspects, the operations of block 524 for rounding the second floating-point value 336 to a nearest odd value 410 may comprise the FPU circuit 330 determining whether the rounded second floating-point value 336 results in a tiebreaker value (e.g., the tiebreaker value 418 of FIG. 4) (block 526). If so, the FPU circuit 330 rounds the second floating-point value 336 using a quarter-ULP bit (such as the quarter-ULP bit 214 of FIG. 2) to avoid a double-round error on a subsequent nearest-even-rounding operation (block 528). Some aspects in which the first floating-point value 334 was a subnormal value may provide that the operations of block 522 for converting the second floating-point value 336 to the floating-point output value 338 formatted according to IEEE-754 comprises converting the second floating-point value 336 using the quarter-ULP bit 214 to avoid a double-round error on a subsequent nearest-even-rounding operation (block 530).

The instruction processing circuit according to aspects disclosed herein and discussed with reference to FIGS. 3, 5A, and 5B may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, laptop computer, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, an avionics system, a drone, and a multicopter.

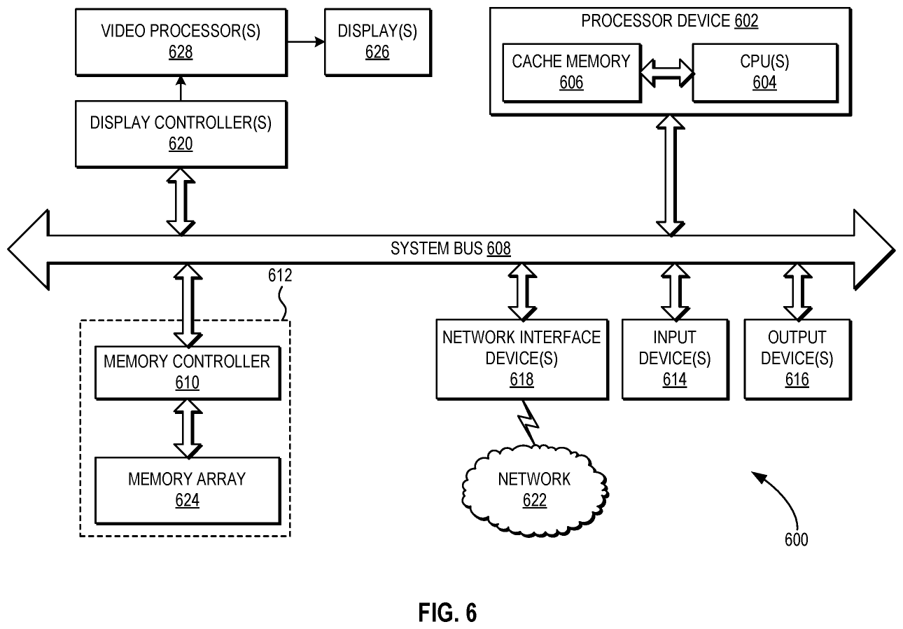

In this regard, FIG. 6 illustrates an example of a processor-based device 600, which corresponds in functionality to the processor-based device 300 of FIG. 3. The processor-based device 600 includes a processor device 602 which comprises one or more CPUs 604 coupled to a cache memory 606. The CPU(s) 604 is also coupled to a system bus 608 and can intercouple devices included in the processor-based device 600. As is well known, the CPU(s) 604 communicates with these other devices by exchanging address, control, and data information over the system bus 608. For example, the CPU(s) 604 can communicate bus transaction requests to a memory controller 610. Although not illustrated in FIG. 6, multiple system buses 608 could be provided, wherein each system bus 608 constitutes a different fabric.

Other devices may be connected to the system bus 608. As illustrated in FIG. 6, these devices can include a memory system 612, one or more input devices 614, one or more output devices 616, one or more network interface devices 618, and one or more display controllers 620, as examples. The input device(s) 614 can include any type of input device, including, but not limited to, input keys, switches, voice processors, etc. The output device(s) 616 can include any type of output device, including, but not limited to, audio, video, other visual indicators, etc. The network interface device(s) 618 can be any devices configured to allow exchange of data to and from a network 622. The network 622 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 618 can be configured to support any type of communications protocol desired. The memory system 612 can include the memory controller 610 coupled to one or more memory arrays 624.

The CPU(s) 604 may also be configured to access the display controller(s) 620 over the system bus 608 to control information sent to one or more displays 626. The display controller(s) 620 sends information to the display(s) 626 to be displayed via one or more video processors 628, which process the information to be displayed into a format suitable for the display(s) 626. The display(s) 626 can include any type of display, including, but not limited to, a cathode ray tube (CRT), a liquid crystal display (LCD), a plasma display, a light emitting diode (LED) display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor device. The master devices and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor device, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor device may be a microprocessor, but in the alternative, the processor device may be any conventional processor device, controller, microcontroller, or state machine. A processor device may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor device such that the processor device can read information from, and write information to, the storage medium. In the alternative, the storage medium may be integral to the processor device. The processor device and the storage medium may reside in an ASIC. The ASIC may reside in a remote station. In the alternative, the processor device and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

Implementation examples are described in the following numbered clauses:
1. A processor device, comprising:
   a register file comprising a plurality of registers; and
   a floating-point unit (FPU) circuit configured to store a first floating-point value in a register of the plurality of registers, the first floating-point value formatted according to an extended QFloat floating-point (xqFP) format comprising:
      an exponent field; and
      a significand field, formatted as a signed one's complement value and comprising:
         a sign bit;
         an explicit most-significant bit (MSB);
         a fractional field; and
         a deferred increment bit that represents a value of one-half (½) unit of least precision (ULP).
2. The processor device of clause 1, wherein:
   the first floating-point value is unnormalized; and
   the explicit MSB indicates a value of an MSB of the first floating-point value.
3. The processor device of any one of clauses 1-2, wherein:
   the first floating-point value formatted according to the xqFP format comprises one of a first representation and a second representation;
   the first representation comprises the significand field storing a numeric value with the deferred increment bit set to a value of zero (0); and
   the second representation comprises the significand field storing the numeric value minus a value of one (1) with the deferred increment bit set to a value of one (1).
4. The processor device of clause any one of clauses 1-3, wherein the FPU circuit is further configured to:
   receive a floating-point input value formatted according to Institute of Electrical and Electronics Engineers (IEEE) Standard for Floating-Point Arithmetic (IEEE-754);
   convert the floating-point input value to the first floating-point value formatted according to the xqFP format;
   perform a floating-point operation using the first floating-point value to generate a second floating-point value formatted according to the xqFP format; and
   convert the second floating-point value to a floating-point output value formatted according to IEEE-754.
5. The processor device of any one of clauses 1-4, wherein:
   the FPU circuit is configured to perform the floating-point operation using the first floating-point value to generate the second floating-point value by being configured to negate the first floating-point value; and
   the FPU circuit is configured to negate the first floating-point value by being configured to perform a one's complement operation on the first floating-point value.
6. The processor device of any one of clauses 1-5, wherein the significand field further comprises a quarter-ULP bit that represents a value of one-fourth (¼) ULP.
7. The processor device of clause 6, wherein:
   the FPU circuit is configured to convert the floating-point input value to the first floating-point value formatted according to the xqFP format by being configured to round the first floating-point value to a nearest even value; and
   the FPU circuit is configured to convert the second floating-point value to the floating-point output value formatted according to IEEE-754 by being configured to round the second floating-point value to a nearest odd value.
8. The processor device of clause 7, wherein:
   the FPU circuit is configured to round the first floating-point value to a nearest even value by being configured to:
      determine whether the floating-point input value is nearest to but less than the nearest even value; and
      responsive to determining that the floating-point input value is nearest to but less than the nearest even value, set the deferred increment bit; and
   the FPU circuit is configured to round the second floating-point value to a nearest odd value by being configured to:
      determine whether the rounded second floating-point value results in a tiebreaker value; and
      responsive to determining that the rounded second floating-point value results in a tiebreaker value, round the second floating-point value using the quarter-ULP bit to avoid a double-round error on a subsequent nearest-even-rounding operation.
9. The processor device any one of clauses 6-8, wherein:
   the floating-point input value comprises a subnormal value;
   the FPU circuit is configured to convert the floating-point input value to the first floating-point value formatted according to the xqFP format by being configured to normalize the subnormal value; and
   the FPU circuit is configured to convert the second floating-point value to the floating-point output value formatted according to IEEE-754 by being configured to convert the second floating-point value using the quarter-ULP bit to avoid a double-round error on a subsequent nearest-even-rounding operation.
10. The processor device of any one of clauses 1-9, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.
11. A processor device, comprising:
   means for receiving a floating-point input value formatted according to Institute of Electrical and Electronics Engineers (IEEE) Standard for Floating-Point Arithmetic (IEEE-754);
   means for converting the floating-point input value to a first floating-point value formatted according to an extended QFloat floating-point (xqFP) format, wherein the first floating-point value formatted according to the xqFP format comprises:
      an exponent field; and
      a significand field, formatted as a signed one's complement value and comprising:
         a sign bit;
         an explicit most-significant bit (MSB);
         a fractional field; and
         a deferred increment bit that represents a value of one-half (½) unit of least precision (ULP);
   means for storing the first floating-point value in a register of a plurality of registers of a register file;
   means for performing a floating-point operation using the first floating-point value to generate a second floating-point value formatted according to the xqFP format; and
   means for converting the second floating-point value to a floating-point output value formatted according to IEEE-754.
12. A method for storing floating-point values according to an extended QFloat floating-point (xqFP) format, the method comprising:
   receiving, by a floating-point unit (FPU) circuit of a processor device, a floating-point input value formatted according to Institute of Electrical and Electronics Engineers (IEEE) Standard for Floating-Point Arithmetic (IEEE-754);
   converting, by the FPU circuit, the floating-point input value to a first floating-point value formatted according to the xqFP format, wherein the first floating-point value formatted according to the xqFP format comprises: an exponent field; and
      a significand field, formatted as a signed one's complement value and comprising:
         a sign bit;
         an explicit most-significant bit (MSB);
         a fractional field; and
         a deferred increment bit that represents a value of one-half (½) unit of least precision (ULP);
   storing, by the FPU circuit, the first floating-point value in a register of a plurality of registers of a register file of the processor device;
   performing, by the FPU circuit, a floating-point operation using the first floating-point value to generate a second floating-point value formatted according to the xqFP format; and
   converting, by the FPU circuit, the second floating-point value to a floating-point output value formatted according to IEEE-754.
13. The method of clause 12, wherein:
   the first floating-point value is unnormalized; and
   the explicit MSB indicates a value of an MSB of the first floating-point value.
14. The method of any one of clauses 12-13, wherein:
   the first floating-point value formatted according to the xqFP format comprises one of a first representation and a second representation;
   the first representation comprises the significand field storing a numeric value with the deferred increment bit set to a value of zero (0); and
   the second representation comprises the significand field storing the numeric value minus a value of one (1) with the deferred increment bit set to a value of one (1).
15. The method of any one of clauses 12-14, wherein:
   performing the floating-point operation using the first floating-point value to generate the second floating-point value comprises negating the first floating-point value; and
   negating the first floating-point comprises performing a one's complement operation on the first floating-point value.
16. The method of any one of clauses 12-15, wherein the significand field further comprises a quarter-ULP bit that represents a value of one-fourth (¼) ULP.
17. The method of clause 16, wherein:
   converting the floating-point input value to the first floating-point value formatted according to the xqFP format comprises rounding the first floating-point value to a nearest even value; and
   converting the second floating-point value to the floating-point output value formatted according to IEEE-754 comprises rounding the second floating-point value to a nearest odd value.
18. The method of clause 17, wherein:
   rounding the first floating-point value to a nearest even value comprises:
      determining that the floating-point input value is nearest to but less than the nearest even value; and
      responsive to determining that the floating-point input value is nearest to but less than the nearest even value, setting the deferred increment bit; and
   rounding the second floating-point value to a nearest odd value comprises:
      determining that the rounded second floating-point value results in a tiebreaker value; and
      responsive to determining that the rounded second floating-point value results in a tiebreaker value, rounding the second floating-point value using the quarter-ULP bit to avoid a double-round error on a subsequent nearest-even-rounding operation.
19. The method of any one of clauses 16-18 wherein:
   the floating-point input value comprises a subnormal value;
converting the floating-point input value to the first floating-point value formatted according to the xqFP format comprises normalizing the subnormal value; and
   converting the second floating-point value to the floating-point output value formatted according to IEEE-754 comprises converting the second floating-point value using the quarter-ULP bit to avoid a double-round error on a subsequent nearest-even-rounding operation.
20. A non-transitory computer-readable medium, having stored thereon computer-executable instructions that, when executed, cause a processor device to:
   receive a floating-point input value formatted according to Institute of Electrical and Electronics Engineers (IEEE) Standard for Floating-Point Arithmetic (IEEE-754);
   convert the floating-point input value to a first floating-point value formatted according to an extended QFloat floating-point (xqFP) format, wherein the first floating-point value formatted according to the xqFP format comprises:
      an exponent field; and
      a significand field, formatted as a signed one's complement value and comprising:
         a sign bit;
         an explicit most-significant bit (MSB);
         a fractional field; and
         a deferred increment bit that represents a value of one-half (½) unit of least precision (ULP);
   store the first floating-point value in a register of a plurality of registers of a register file of the processor device;
   perform a floating-point operation using the first floating-point value to generate a second floating-point value formatted according to the xqFP format; and
   convert the second floating-point value to a floating-point output value formatted according to IEEE-754.
21. The non-transitory computer-readable medium of clause 20, wherein:
   the first floating-point value is unnormalized; and
   the explicit MSB indicates a value of an MSB of the first floating-point value.
22. The non-transitory computer-readable medium of any one of clauses 20-21, wherein:
   the first floating-point value formatted according to the xqFP format comprises one of a first representation and a second representation;
   the first representation comprises the significand field storing a numeric value with the deferred increment bit set to a value of zero (0); and
   the second representation comprises the significand field storing the numeric value minus a value of one (1) with the deferred increment bit set to a value of one (1).
23. The non-transitory computer-readable medium of any one of clauses 20-22, wherein:
   the computer-executable instructions cause the processor device to perform the floating-point operation using the first floating-point value to generate the second floating-point value by causing the processor device to negate the first floating-point value; and
   the computer-executable instructions cause the processor device to negate the first floating-point by causing the processor device to perform a one's complement operation on the first floating-point value.
24. The non-transitory computer-readable medium of any one of clauses 20-23, wherein the significand field further comprises a quarter-ULP bit that represents a value of one-fourth (¼) ULP.
25. The non-transitory computer-readable medium of clause 24, wherein:
   the computer-executable instructions cause the processor device to convert the floating-point input value to the first floating-point value formatted according to the xqFP format by causing the processor device to round the first floating-point value to a nearest even value; and
   the computer-executable instructions cause the processor device to convert the second floating-point value to the floating-point output value formatted according to IEEE-754 by causing the processor device to round the second floating-point value to a nearest odd value.
26. The non-transitory computer-readable medium of clause 25, wherein:
   the computer-executable instructions cause the processor device to round the first floating-point value to a nearest even value by causing the processor device to:
      determine whether the floating-point input value is nearest to but less than the nearest even value; and
      responsive to determining that the floating-point input value is nearest to but less than the nearest even value, set the deferred increment bit;
   and the computer-executable instructions cause the processor device to round the second floating-point value to a nearest odd value by causing the processor device to:
      determine whether the rounded second floating-point value results in a tiebreaker value; and
      responsive to determining that the rounded second floating-point value results in a tiebreaker value, round the second floating-point value using the quarter-ULP bit to avoid a double-round error on a subsequent nearest-even-rounding operation.
27. The non-transitory computer-readable medium of any one of clauses 24-26, wherein:
   the floating-point input value comprises a subnormal value;
   the computer-executable instructions cause the processor device to convert the floating-point input value to the first floating-point value formatted according to the xqFP format by causing the processor device to normalize the subnormal value; and
   the computer-executable instructions cause the processor device to convert the second floating-point value to the floating-point output value formatted according to IEEE-754 by causing the processor device to convert the second floating-point value using the quarter-ULP bit to avoid a double-round error on a subsequent nearest-even-rounding operation.

What is claimed is:

1. A processor device, comprising:
a register file comprising a plurality of registers; and
a floating-point unit (FPU) circuit configured to store a first floating-point value in a register of the plurality of registers, the first floating-point value formatted according to an extended QFloat floating-point (xqFP) format comprising:
an exponent field; and
a significand field, formatted as a signed one's complement value and comprising:
a sign bit;
an explicit most-significant bit (MSB);
a fractional field; and
a deferred increment bit that represents a value of one-half (½) unit of least precision (ULP).

2. The processor device of claim 1, wherein:
the first floating-point value is unnormalized; and
the explicit MSB indicates a value of an MSB of the first floating-point value.

3. The processor device of claim 1, wherein:
the first floating-point value formatted according to the xqFP format comprises one of a first representation and a second representation;
the first representation comprises the significand field storing a numeric value with the deferred increment bit set to a value of zero (0); and
the second representation comprises the significand field storing the numeric value minus a value of one (1) with the deferred increment bit set to a value of one (1).

4. The processor device of claim 1, wherein the FPU circuit is further configured to:
receive a floating-point input value formatted according to Institute of Electrical and Electronics Engineers (IEEE) Standard for Floating-Point Arithmetic (IEEE-754);
convert the floating-point input value to the first floating-point value formatted according to the xqFP format;
perform a floating-point operation using the first floating-point value to generate a second floating-point value formatted according to the xqFP format; and
convert the second floating-point value to a floating-point output value formatted according to IEEE-754.

5. The processor device of claim 1, wherein:
the FPU circuit is configured to perform the floating-point operation using the first floating-point value to generate the second floating-point value by being configured to negate the first floating-point value; and
the FPU circuit is configured to negate the first floating-point value by being configured to perform a one's complement operation on the first floating-point value.

6. The processor device of claim 1, wherein the significand field further comprises a quarter-ULP bit that represents a value of one-fourth (¼) ULP.

7. The processor device of claim 6, wherein:
the FPU circuit is configured to convert the floating-point input value to the first floating-point value formatted according to the xqFP format by being configured to round the first floating-point value to a nearest even value; and
the FPU circuit is configured to convert the second floating-point value to the floating-point output value formatted according to IEEE-754 by being configured to round the second floating-point value to a nearest odd value.

8. The processor device of claim 7, wherein:
the FPU circuit is configured to round the first floating-point value to a nearest even value by being configured to:
determine whether the floating-point input value is nearest to but less than the nearest even value; and
responsive to determining that the floating-point input value is nearest to but less than the nearest even value, set the deferred increment bit; and
the FPU circuit is configured to round the second floating-point value to a nearest odd value by being configured to:
determine whether the rounded second floating-point value results in a tiebreaker value; and
responsive to determining that the rounded second floating-point value results in a tiebreaker value, round the second floating-point value using the quarter-ULP bit to avoid a double-round error on a subsequent nearest-even-rounding operation.

9. The processor device of claim 6, wherein:
the floating-point input value comprises a subnormal value;
the FPU circuit is configured to convert the floating-point input value to the first floating-point value formatted according to the xqFP format by being configured to normalize the subnormal value; and
the FPU circuit is configured to convert the second floating-point value to the floating-point output value formatted according to IEEE-754 by being configured to convert the second floating-point value using the quarter-ULP bit to avoid a double-round error on a subsequent nearest-even-rounding operation.

10. The processor device of claim 1, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

11. A processor device, comprising:
means for receiving a floating-point input value formatted according to Institute of Electrical and Electronics Engineers (IEEE) Standard for Floating-Point Arithmetic (IEEE-754);
means for converting the floating-point input value to a first floating-point value formatted according to an extended QFloat floating-point (xqFP) format, wherein the first floating-point value formatted according to the xqFP format comprises:
an exponent field; and
a significand field, formatted as a signed one's complement value and comprising:
a sign bit;
an explicit most-significant bit (MSB);
a fractional field; and
a deferred increment bit that represents a value of one-half (½) unit of least precision (ULP);
means for storing the first floating-point value in a register of a plurality of registers of a register file;
means for performing a floating-point operation using the first floating-point value to generate a second floating-point value formatted according to the xqFP format; and
means for converting the second floating-point value to a floating-point output value formatted according to IEEE-754.

12. A method for storing floating-point values according to an extended QFloat floating-point (xqFP) format, the method comprising:
receiving, by a floating-point unit (FPU) circuit of a processor device, a floating-point input value formatted according to Institute of Electrical and Electronics Engineers (IEEE) Standard for Floating-Point Arithmetic (IEEE-754);
converting, by the FPU circuit, the floating-point input value to a first floating-point value formatted according to the xqFP format, wherein the first floating-point value formatted according to the xqFP format comprises:
an exponent field; and
a significand field, formatted as a signed one's complement value and comprising:
a sign bit;
an explicit most-significant bit (MSB);
a fractional field; and
a deferred increment bit that represents a value of one-half (½) unit of least precision (ULP);
storing, by the FPU circuit, the first floating-point value in a register of a plurality of registers of a register file of the processor device;
performing, by the FPU circuit, a floating-point operation using the first floating-point value to generate a second floating-point value formatted according to the xqFP format; and
converting, by the FPU circuit, the second floating-point value to a floating-point output value formatted according to IEEE-754.

13. The method of claim 12, wherein:
the first floating-point value is unnormalized; and
the explicit MSB indicates a value of an MSB of the first floating-point value.

14. The method of claim 12, wherein:
the first floating-point value formatted according to the xqFP format comprises one of a first representation and a second representation;
the first representation comprises the significand field storing a numeric value with the deferred increment bit set to a value of zero (0); and
the second representation comprises the significand field storing the numeric value minus a value of one (1) with the deferred increment bit set to a value of one (1).

15. The method of claim 12, wherein:
performing the floating-point operation using the first floating-point value to generate the second floating-point value comprises negating the first floating-point value; and
negating the first floating-point comprises performing a one's complement operation on the first floating-point value.

16. The method of claim 12, wherein the significand field further comprises a quarter-ULP bit that represents a value of one-fourth (¼) ULP.

17. The method of claim 16, wherein:
converting the floating-point input value to the first floating-point value formatted according to the xqFP format comprises rounding the first floating-point value to a nearest even value; and
converting the second floating-point value to the floating-point output value formatted according to IEEE-754 comprises rounding the second floating-point value to a nearest odd value.

18. The method of claim 17, wherein:
rounding the first floating-point value to a nearest even value comprises:
determining that the floating-point input value is nearest to but less than the nearest even value; and
responsive to determining that the floating-point input value is nearest to but less than the nearest even value, setting the deferred increment bit; and
rounding the second floating-point value to a nearest odd value comprises:
determining that the rounded second floating-point value results in a tiebreaker value; and
responsive to determining that the rounded second floating-point value results in a tiebreaker value, rounding the second floating-point value using the quarter-ULP bit to avoid a double-round error on a subsequent nearest-even-rounding operation.

19. The method of claim 16, wherein:
the floating-point input value comprises a subnormal value;
converting the floating-point input value to the first floating-point value formatted according to the xqFP format comprises normalizing the subnormal value; and
converting the second floating-point value to the floating-point output value formatted according to IEEE-754 comprises converting the second floating-point value using the quarter-ULP bit to avoid a double-round error on a subsequent nearest-even-rounding operation.

20. A non-transitory computer-readable medium, having stored thereon computer-executable instructions that, when executed, cause a processor device to:
receive a floating-point input value formatted according to Institute of Electrical and Electronics Engineers (IEEE) Standard for Floating-Point Arithmetic (IEEE-754);
convert the floating-point input value to a first floating-point value formatted according to an extended QFloat floating-point (xqFP) format, wherein the first floating-point value formatted according to the xqFP format comprises:
an exponent field; and
a significand field, formatted as a signed one's complement value and comprising:
a sign bit;
an explicit most-significant bit (MSB);
a fractional field; and
a deferred increment bit that represents a value of one-half (½) unit of least precision (ULP);
store the first floating-point value in a register of a plurality of registers of a register file of the processor device;
perform a floating-point operation using the first floating-point value to generate a second floating-point value formatted according to the xqFP format; and
convert the second floating-point value to a floating-point output value formatted according to IEEE-754.

21. The non-transitory computer-readable medium of claim 20, wherein:
the first floating-point value is unnormalized; and
the explicit MSB indicates a value of an MSB of the first floating-point value.

22. The non-transitory computer-readable medium of claim 20, wherein:
the first floating-point value formatted according to the xqFP format comprises one of a first representation and a second representation;
the first representation comprises the significand field storing a numeric value with the deferred increment bit set to a value of zero (0); and
the second representation comprises the significand field storing the numeric value minus a value of one (1) with the deferred increment bit set to a value of one (1).

23. The non-transitory computer-readable medium of claim 20, wherein:
the computer-executable instructions cause the processor device to perform the floating-point operation using the first floating-point value to generate the second floating-point value by causing the processor device to negate the first floating-point value; and
the computer-executable instructions cause the processor device to negate the first floating-point by causing the processor device to perform a one's complement operation on the first floating-point value.

24. The non-transitory computer-readable medium of claim 20, wherein the significand field further comprises a quarter-ULP bit that represents a value of one-fourth (¼) ULP.

25. The non-transitory computer-readable medium of claim 24, wherein:
the computer-executable instructions cause the processor device to convert the floating-point input value to the first floating-point value formatted according to the xqFP format by causing the processor device to round the first floating-point value to a nearest even value; and
the computer-executable instructions cause the processor device to convert the second floating-point value to the floating-point output value formatted according to IEEE-754 by causing the processor device to round the second floating-point value to a nearest odd value.

26. The non-transitory computer-readable medium of claim 25, wherein:
the computer-executable instructions cause the processor device to round the first floating-point value to a nearest even value by causing the processor device to:
determine whether the floating-point input value is nearest to but less than the nearest even value; and
responsive to determining that the floating-point input value is nearest to but less than the nearest even value, set the deferred increment bit; and
the computer-executable instructions cause the processor device to round the second floating-point value to a nearest odd value by causing the processor device to:
determine whether the rounded second floating-point value results in a tiebreaker value; and
responsive to determining that the rounded second floating-point value results in a tiebreaker value, round the second floating-point value using the quarter-ULP bit to avoid a double-round error on a subsequent nearest-even-rounding operation.

27. The non-transitory computer-readable medium of claim 24, wherein:
the floating-point input value comprises a subnormal value;
the computer-executable instructions cause the processor device to convert the floating-point input value to the first floating-point value formatted according to the xqFP format by causing the processor device to normalize the subnormal value; and
the computer-executable instructions cause the processor device to convert the second floating-point value to the floating-point output value formatted according to IEEE-754 by causing the processor device to convert the second floating-point value using the quarter-ULP bit to avoid a double-round error on a subsequent nearest-even-rounding operation.
